(19) United States
(12) Patent Application Publication
(10) Pub. No.: US 2015/0124612 A1
(43) Pub. Date: May 7, 2015

(54) MULTI-TENANT NETWORK PROVISIONING

(71) Applicants: Michael Schlansker, Los Altos, CA (US); Jean Tourrihes, Mountain View, CA (US); Jose Renato G. Santos, Morgan Hill, CA (US)

(72) Inventors: Michael Schlansker, Los Altos, CA (US); Jean Tourrihes, Mountain View, CA (US); Jose Renato G. Santos, Morgan Hill, CA (US)

(21) Appl. No.: 14/397,425

(22) PCT Filed: Jun. 7, 2012
(86) PCT No.: PCT/US12/41421

§ 371 Date: Oct. 27, 2014

(51) Int. Cl. H04L 12/927; H04L 12/813; H04L 12/823; H04L 12/851

(52) U.S. Cl. CPC H04L 47/805; H04L 47/2433; H04L 47/20; H04L 47/32; H04L 47/808
USPC 370/235

(57) ABSTRACT

Multi-tenant network provisioning is disclosed. An example method of multi-tenant network provisioning includes setting at least one rate limiter on output ports of a node in the network on a tenant-by-tenant basis. The method also includes enforcing communication rates over shared edge links based on the rate limiter.

### BACKGROUND

Increasingly, datacenter hardware is purchased by infrastructure vendors and is used to support compute, storage, and communication services that are sold to independent “tenants” in the data center. Large scale data centers move packets for the tenants via multiple paths in network fabrics, with each packet passing through consecutive point-to-point links and switching nodes. At each switching node, packets may converge from many source links onto one destination link, may diverge from one source link to many destination links, or any permutation thereof.

The provisioning of communications in the network fabric is complex and poorly understood. Unlike traditional compute and storage provisioning, communications provisioning suffers from shared internal resources within communications networks that may have arbitrary and complex topologies.

### BRIEF DESCRIPTION OF THE DRAWINGS

FIG. 1 is a high-level diagram of en example network fabric which may implement multi-tenant network provisioning.

FIG. 2a is an illustration of an example unprotected shared network.

FIG. 2b is an illustration of an example protected shared network.

FIG. 3 is a node diagram illustrating example port switching rates for network provisioning.

FIG. 4 is a component diagram of an example switch enabled for network provisioning.

FIG. 5 is a high level illustration showing example rate control for network provisioning.

FIG. 6 is a node diagram illustrating an example fabric implementing network provisioning.

FIG. 7 is a node diagram illustrating a more complex example fabric implementing network provisioning.

FIGS. 8-10 are flowcharts illustrating example operations which may be implemented for multi-tenant network provisioning.

### DETAILED DESCRIPTION

Provisioning communications resources for data center networks is disclosed. Increasingly, datacenter hardware is purchased by infrastructure vendors and used to support compute, storage, and communication services that are sold to independent tenants. Shared data centers such as this are referred to herein as infrastructure as a Service (IaaS). IaaS provides economy of scale and other efficiencies not previously Possible. Service Level Agreements (SLAs) may be used to define a level of service that an infrastructure vendor provides to the tenant. Network architectures are designed to provide Quality of Service (QoS) to provide sufficient resources and ensure that the tenant SLAs are satisfied.

The provisioning of communications capability can be complex. Unlike compute and storage provisioning, communications provisioning suffers from shared internal resources within communications networks that may have arbitrary and complex topologies. Accordingly, communications provisioning and enforcement has to address complex fabric-wide decision processes, where many provisioning and enforcement decisions are interdependent.

Datacenter communication networks are increasingly complex as multipath networks are used for high performance communications within very large datacenters. Guaranteed QoS for communications within a shared network has remained an unsolved issue. Even when a multipath network is over-provisioned beyond normal communication needs, computer software executed by one tenant can generate patterns of communication traffic that disrupt communications for another tenant. This results in a failure to ensure QoS for other tenants, and results in unacceptable performance when the other tenants are sharing the network infrastructure.

Systems and methods of multi-tenant network provisioning disclosed herein address these issues. In an example, multi-tenant network provisioning includes setting at least one rate limiter on output ports of a node in the network on a tenant-by-tenant basis. In addition, communication rates are enforced over shared edge links based on the rate limiter.

Traffic rates can be managed either within or outside the network. Traffic is managed outside the network by host software (e.g., a hypervisor when multiple software-based tenants share host hardwares). Host-based management controls traffic rates at fabric ingresses and can reduce the need for in-fabric management. Traffic rates are managed within the fabric by switches that are enabled to support the systems and methods as described in more detail below.

Before continuing, it is noted that as used herein, the terms “includes” and “including” mean but are not limited to, “includes” or “including” and “includes at least” or “including at least.” The term “based on” means “based on” and “based at least in part on.”

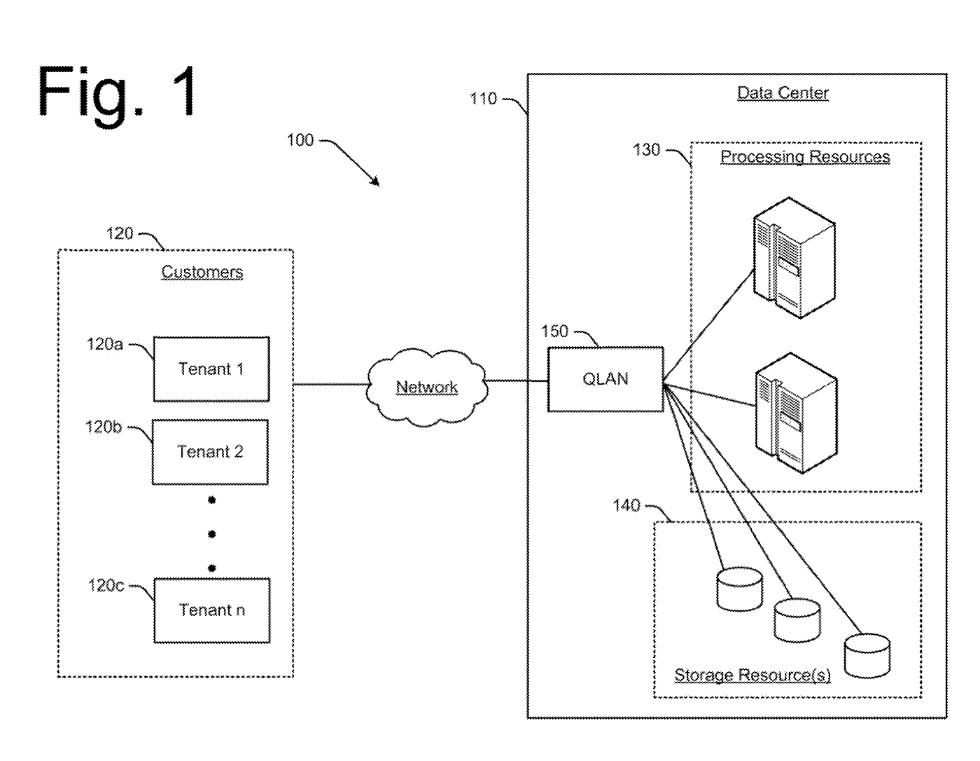

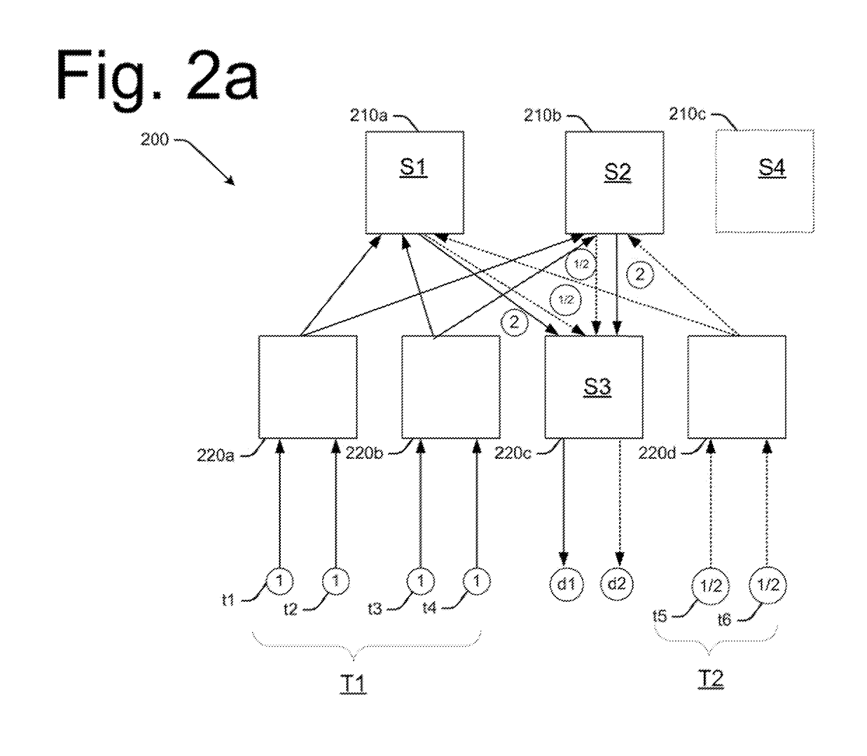

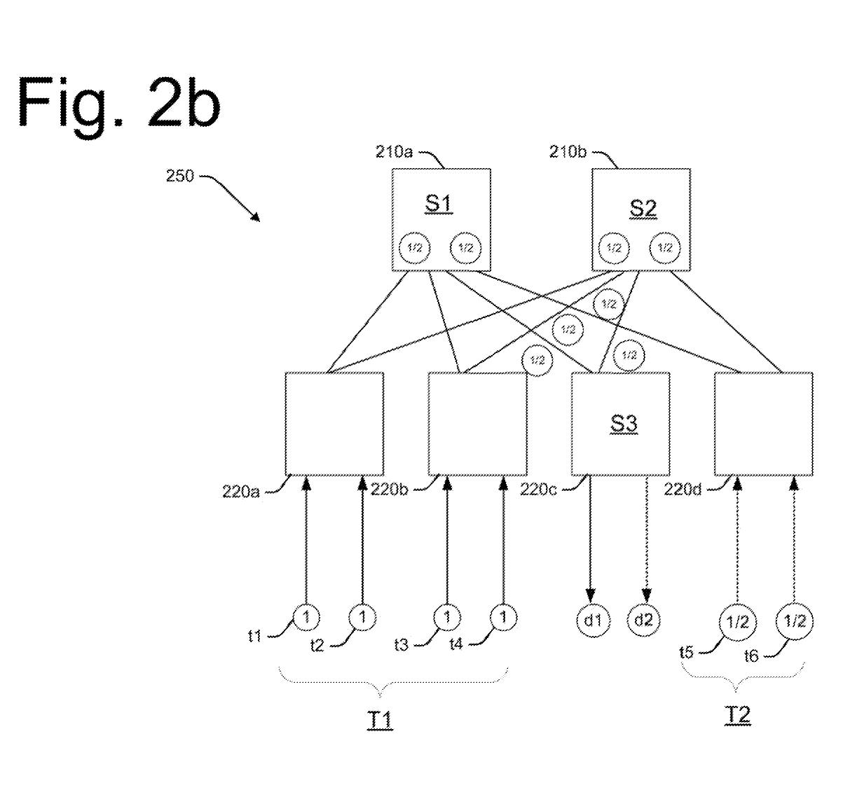

FIG. 1 is a high-level diagram of an example system 100 which may implement multi-tenant network provisioning of a network fabric interconnecting resources in a data center 110. The data center 110 provides multiple tenants customers 120 (e.g., tenants 120a-c) access to resources (some shared, others not shared), such as processing resources 130 and storage resources 140, via the network fabric. The network fabric may be implemented as a switched fabric (see, e.g., FIGS. 2a and 2b). Example fabrics include, but are not limited to, switched fabrics such as Ethernet. Other types of fabrics may include InfiniBand, QPI, Hypertransport, and PCIe. These fabrics are usually implemented with routers which preserve packet order, except where mandatory passing is required by protocol ordering rules. Ordered queues, such as first-in-first-out (FIFO) queues, are usually used because these are relatively simple to implement, and in some cases because of protocol ordering requirements, or because the application of more complex queuing structures is not viable within the very short times needed to achieve acceptable fabric performance.

In an example, the switched fabric may include nodes, such as source nodes generating packet(s) to be transmitted via switching nodes to destination node(s). The switching nodes may be implemented as crossbar chips within the switched fabric (e.g., connecting processor chips together in a computer system). The nodes may include queues (e.g., implemented in a latch array) for storing packets waiting to be sent on outbound links.

When routes converge within a switching node, there is potential for bottlenecks, because many links converging upon a single link can potentially overwhelm that link's capacity. Convergence should not create bottlenecks in a well-designed fabric with well-behaved traffic, because there will also be compensating divergence. Each of the switching node input links participating in the convergence pattern would also carry packets that diverge to many switching node output links, so that the combined fraction of arriving packets from all inputs of the switching node targeting any given output is small enough to avoid overloading that output link. That is, traffic arriving at each of input ports of a switching node might divide itself equally between output ports. Because only about half of the first input traffic goes to one of the outputs, as does about half of the second input traffic, the total traffic on is about the same as on one of the inputs. The two-to-one convergence at the outputs is offset by one-to-two divergence at the inputs.

However, under less ideal conditions, aggravating factors, such as large poorly behaved workloads from more “aggressive” tenants in the data center, can cause convergence to exceed divergence and result in overloading one or more of the switching nodes. When this occurs, backpressure propagates, filling queues in upstream switching nodes and/or resulting in lost packets. The switched fabric may be managed with a QLAN 150, which can be better understood with reference to the illustration in FIGS. 2a and 2b.

FIG. 2a is an illustration of an example unprotected shared network 200 FIG. 2b is an illustration of an example protected shared network 250. FIG. 2a shows an example Clos network, with two top switches 210a-b (S1 and S2) and four edge switches 220a-d (including switch S3). The example network is a fully provisioned (referred to as a “non-blocking”) Clos network, that can support any traffic permutation without congestion. Two tenants T1 and 12 share the network. Tenant T1 has purchased 5 unit-bandwidth ports while tenant 12 has purchased 3 unit bandwidth ports. Tenant T2 is a “well-behaved” tenant that is currently driving one out of two (1/2) units of communication traffic from each of the ports t5-t6 to the destination port shown as “d2” in FIG. 2a. Tenant T2 paid for (and thus expects) uninterrupted service for a single unit of communication load targeting the destination port d2.

Tenant T1 is consuming bandwidth in a poorly designed manner, and thus is a “poorly behaved” tenant. For example, tenant T1 may be executing faulty software that sends one (“1”) unit of traffic from the four ports t1-t4 to a single destination port marked “d1”. Of course, the single destination port d1 is insufficient to properly handle the total four units of input traffic from tenant T1. In this example, traffic from both tenants T1 and T2 is evenly divided across the two top switches S1 and S2. This results in a total load of 2.5 units of bandwidth on each of two links that go from switches S1 and S2 to the destination switch S3. However, physical links carry only a single unit of traffic, and thus the queues in switches S1 and S2 fill at a rate far faster than the queues can be drained. As a result, packets are dropped for both tenants T1 and T2, and tenant T2 experiences poor communication performance due to the tenant T1's troublesome software.

Over-provisioning the network (e.g., by providing additional hardware) can be expensive and does not make good use of the hardware resources. But even if an additional switch S4 is provided in the example shown in FIG. 2a (the fabric is over-provisioned), and traffic is spread over three top switches S1, S2 and S4, inter-tenant interference still cannot be completely eliminated, because traffic interference still occurs among tenants in the interior of more complex networks. Other solutions cannot be well implemented with the limited processing and memory resources on a switch.

Instead, the network fabric may be provisioned for tenants on a per-tenant Qos basis using what is introduced herein as a queued local area network (QLAN). A QLAN incorporates aspects of a virtual LAN (VLAN), and adds control over link access rate while supporting virtualization for a large number of tenants. FIG. 2b illustrates a Clos network that is provisioned for shared access as a QLAN.

In this illustration, the tenant T1 is provisioned within the network with 4 ports having a bandwidth allocation for each port. Such a uniform allocation may be referred to as a “hose.” The tenant T1 is identified with a QoS tad that is carried in the packet. The QoS tag provides a large namespace that supports many distinct tenants.

Traffic rates can be managed ether within or outside the network. Traffic is managed outside the network by host software, such as a hypervisor, when multiple software-based tenants share host hardware. Host-based management controls traffic rates at fabric ingresses and reduce the need for in-fabric management. Traffic rates are managed within the fabric by switches that are enhanced to support QLANs.

Each QLAN defines a tree that carries traffic from sources to destinations. A feature of the QLAN is demonstrated in situations when too much tenant source traffic is sent to tenant destinations having too little capacity. In this case, packets are dropped before disrupting other tenants sharing the network. This may be implemented using a rule (r).

In an example, the rule states that the allowed bandwidth for accessing an egress link is the lesser of the sum of sources that supply traffic to a link through the switch and, the sum of destinations that are reached by that link. The rule exploits a network-wide understanding of the tenant SLA, the physical network topology, and a chosen allocation for network resources to provide a static and local per-port bandwidth allocation needed to support tenant communication. This local rate supports legitimate worst case tenant traffic.

In the illustration shown in FIG. 2b, traffic from tenant T1 is managed using traffic rate limiters that control the egress ports that are traversed by the tenant's communication traffic. Fabric-edge ports are managed by hypervisors, and interior ports are managed by switches. This approach controls the allowed egress rate at every egress port leading to a bandwidth-limited network link. It can be seen in FIG. 2b, that each tenant is receiving communication bandwidth in the network according to the agreed upon QoS. That is, both tenants T1 and T2 are forced to be “well-behaved” tenants driving one out of two (1/2) units of communication traffic from each of the ports to the destination port d2 in FIG. 2b.

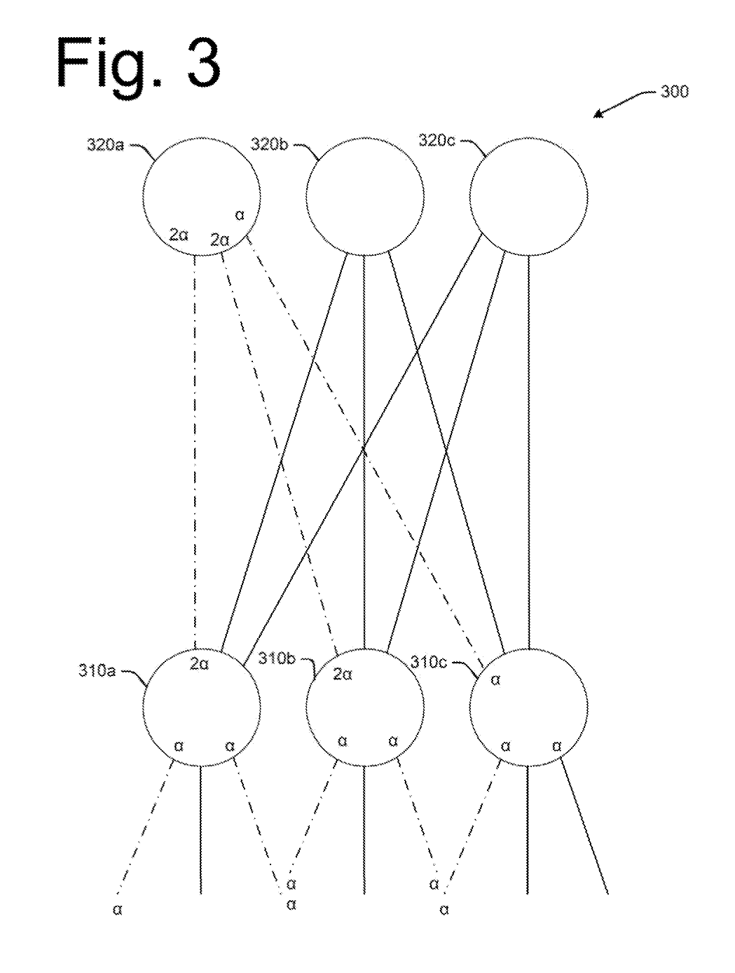

FIG. 3 is a node diagram 300 illustrating example port switching rates for network provisioning. In this example, three edge switches 310a-c and three top switches 320a-c are provided in the fabric for two tenants T1 and T2. Traffic for tenant T1 is shown as dashed lines in the fabric, and traffic for tenant T2 is shown as solid lines in the fabric.

The rule r defined above may be used to “mark” every egress port for tenant T1 with appropriate rates. In this example, a QLAN defines a virtual network that implements a 5-port hose SLA that provides bandwidth α on, each network access link. The ingress and egress bandwidths allowed on all links are identical in a symmetric example such as this. The switch hardware uses pre-calculated static rates to guarantee that tenant T1 is constrained to operate within a minimal set of static resources needed to support the SLA for tenant T1 without interfering with the SLA for tenant T2.

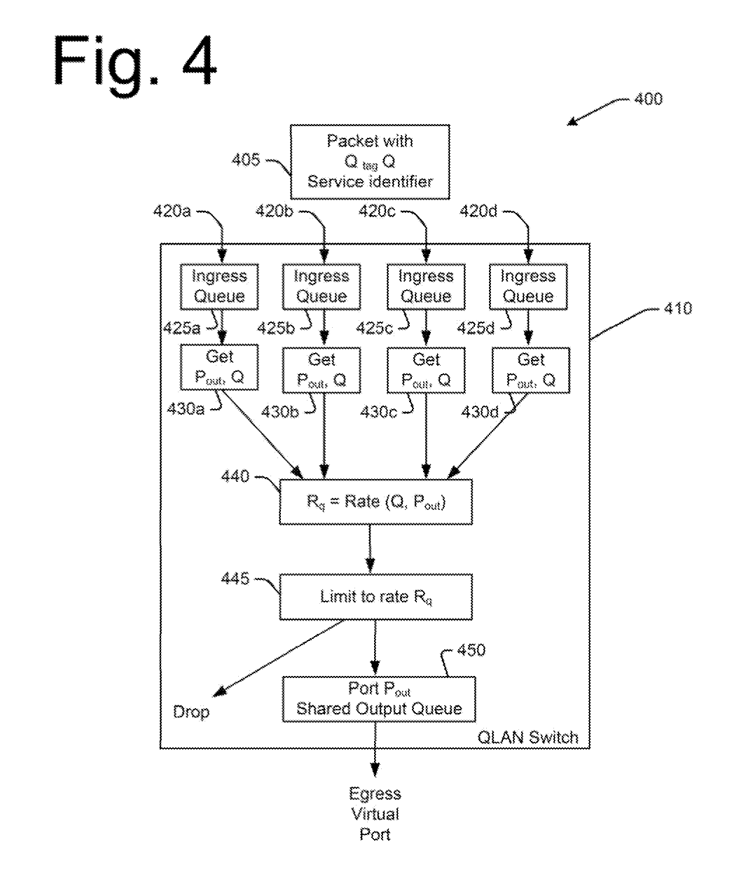

FIG. 4 is a component diagram 400 of an example switch 410 enabled for network provisioning. In this example, the switch 410 is a QLAN-enabled switch. Processing begins after packets 405 arrive via ingress ports 420a-d at corresponding ingress queues 425a-d. The packets are processed at modules 430a-d, and Ethernet forwarding information such as the destination MAC address and a VLAN tag are extracted and used to calculate an output port (Pₒᵤₜ) that is used to forward the packet. A QoS tag (Q) indicates the QLAN service ID, or tenant ID, and is carried in and extracted from the packet. A tuple including Q and Pₒᵤₜ is formed and provides an index into a table of rates 440. A table lookup produces a rate (Rq) that controls the output flow rate for the given QLAN and output port. If module 445 determines the delivery is within the rate Rq, the packet is delivered via module 450 to the appropriate egress virtual port. If module 445 determines the delivery exceeds the rate, then the packet is dropped as illustrated in FIG. 4.

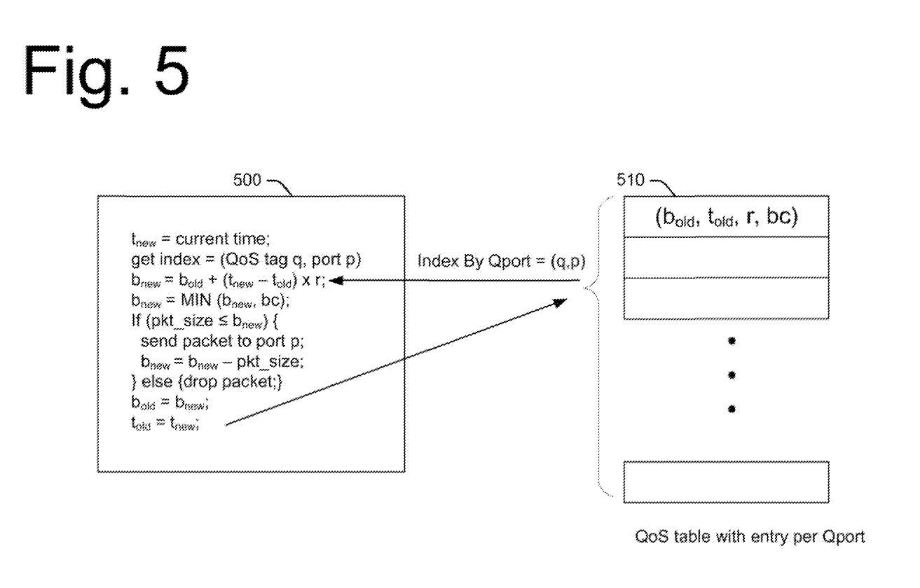

Because rate processing is performed on every packet, and many virtual rate limiters are stored in each switch, QLAN processing should be implemented efficiently with respect to the sivitchns computational and memory resources. An example rate-limiter utilizes a single 64 bit table entry for each rate limiter, and processes the table entry with a single read-modify-write each time a packet accesses the entry. This design implements a traditional token bucket using two static values that define the rate for each guarded port. A burst capacity (bc) defines the allowed burst size. The rate defines the allowed sustained transmission rate. Each token bucket maintains a dynamic bucket value b. When an arriving packet has size greater than b, the packet is dropped. Otherwise the packet is sent and b is decremented by the packet size. The bucket value is incremented every 1/r seconds, but the maximum value never exceeds bc. An example process is illustrated in FIG. 5.

FIG. 5 is a high level illustration showing example rate control for network provisioning. In this example, a rate control algorithm 500 is implemented using a single 64-bit read-modify-write into a large table 510 that maintains a value for each control ad virtual port. Each time a packet arrives, the table is indexed and read. Next, the packet is conditionally sent or dropped, and an updated table value is restored.

In an example, a bucket is defined by a 4-tuple including a 16-bit bucket level, a 28 bit prior time, a 12-bit rate, and an 8-bit burst capacity. The bucket, time, rate, and capacity values may be scaled to optimize field usage. The old time value is incorporated into the 4-tuple to eliminate the need to continuously augment he bucket value. When a packet arrives, a current time is acquired from the switch clock. The bucket 4-tuple is accessed and spot into four constituent values. A new bucket value b_{new} is calculated using the difference between new and old time.

The bucket value may be capped and then compared with the packet size. The packet is sent conditionally if the packet “fits” in the bucket. If sent, the bucket value is diminished by the packet size. The new bucket value and time are saved back to the bucket control table. While this approach eliminates periodic bucket updates, the approach may introduce ambiguity when significant time passes between bucket accesses. This may cause minor rate-control inaccuracies that can be reduced by allocating more bits to represent time.

Architectures that manage tenants within network switches are often dismissed, because these use a management state for each tenant. Because switches provide a limited management state, the states may be reduced when a large number of tenants are deployed.

For purposes of illustration, tenants may be allocated as a private virtual network defined as a “hose.” The tenant “rents” virtual switch having four ports each with bandwidth ∝. This somewhat primitive hose SLA allocates four virtual ports each with ingress and egress capacity ∝. In addition, the SLA specifies that the tenant has sufficient network hardware connecting the ports so that well-behaved traffic consistent with specified virtual bandwidths can be supported.

To minimize use of an in-network management state, opportunistically allowing bandwidth beyond a tenant's SLA may be permitted if the bandwidth does not interfere with other tenants. In addition, multiple tenants sharing a physical link may be hosted on a hypervisor that implements a QLAN-enabled virtual switch when rate enforcement can be performed in the host software. When a switch has no rate limiting entry for a specific QLAN virtual port (Qport), then traffic passes through that Qport without control. Thus, the default state for a Qport is open (the rate is ∞).

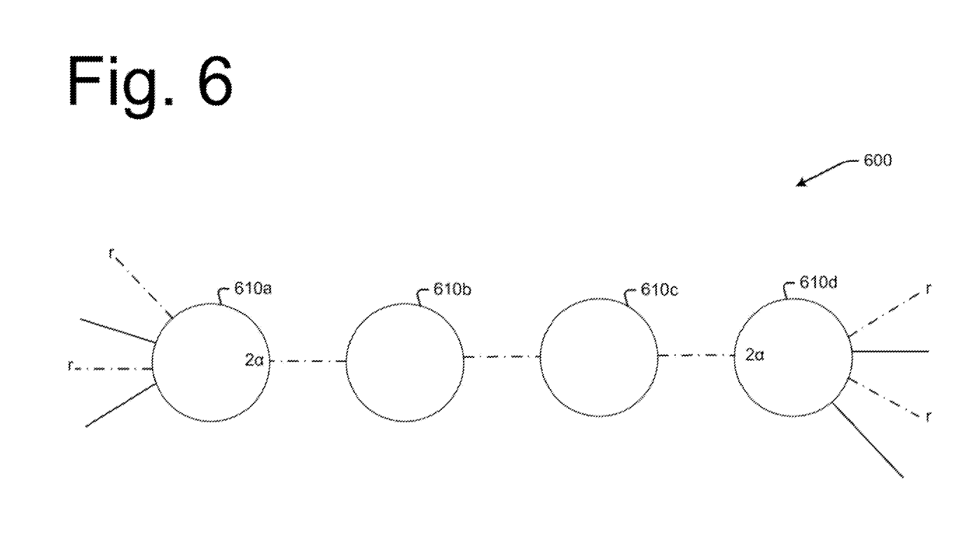

FIG. 6 is a node diagram illustrating an example simplified fabric 600 implementing network provisioning. The tenant T1 may be a bare-machine tenant that is hosted on processors which do not run hypervisors. Tenant T1 owns four physical hosts, each with a dedicated link (shown as dashed lines). The remaining networks links (shown as solid lines) are used by other tenants. Tenant T1 ingress rates “r” are marked at each of the switches 610a-d (where r=∞ to indicate that ingress traffic runs at the full hardware lire rate without artificial rate controls in software or hardware).

Without any rate limiters, ingress traffic might overload the network and disrupt other tenants (not shown). However, two rate limiters 2∝ are strategically positioned at merge points, and serve to prevent inter-tenant interference. The number of rate limiters can be optimized to both allow excess in-tenant bandwidth on unshared resources, while protecting shared resources. Accordingly, the SLA allows tenant T1 to “legally” pass 2∝ units of traffic through the center of the network in either direction, and tenant T1 is rate limited to this amount of traffic.

Tenant T1 cannot send traffic to the unshared edge links, because no destination addresses for tenant T1 cause forwarding to these links. It is noted that tenant T1 may opportunistically receive extra bandwidth between the outer ports designated by r without impacting shared links. Additional rate limiters may be added to remove such opportunistic excess benefits, but these rate limiters do not protect other tenants and thus can be omitted to minimize in-switch state.

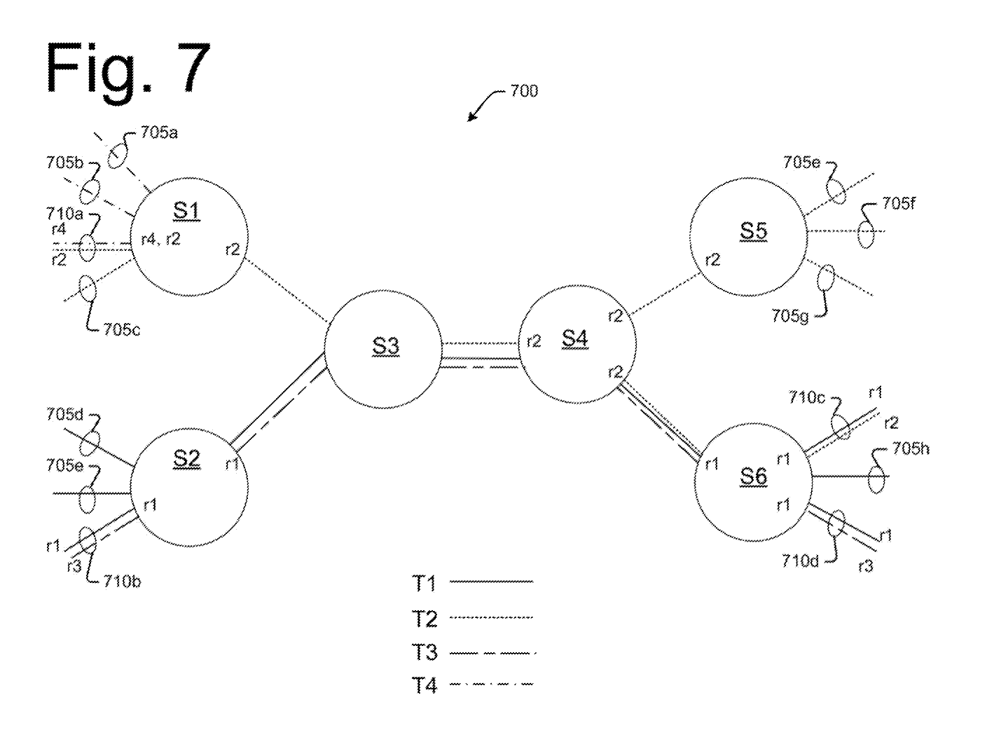

Global reasoning as defined herein means an overall assessment of the fabric and the SLA or tenant guarantees to determine bandwidth allocation and the development of a local rule or set of local rules, and optimizing positioning of those rules in the fabric, to handle bandwidth across multiple tenants to impose limits on each tenants ability to disrupt communication services that are allocated in the SLAs of other tenants. Examples are illustrated in FIG. 7.

FIG. 7 is a node diagram illustrating a more complex fabric 700 implementing network provisioning. In this example, four tenants T1-T4 are allocated on virtual LAN networks. Both dedicated edge ports 705a-h and shared edge ports 710a-d are shown. Shared edge ports 710a-d use virtual switch software to enforce communication rates over shared edge links. The marking “r” indicates that a rate limiter is implemented on the port (although no specific rate value is shown). In this example, marking r1 is a rate limiter for tenant T1, marking r2 is a rate limiter for tenant T2, and so forth.

Tenant T4 is shown spanning the fabric 700, but traffic enforcement is only performed at the edge (and entirely in host software for no other switches in the fabric 700). Thus, tenant T4 can be managed using one limiter in host software and one in-switch limiter within the switch S2. Tenant T1 also spans the fabric 700, but rate limiters r are not needed in the switches S3 and S4. Tenant T2 has merging traffic that spans three port into a central switch S3, and rate limiters are thus needed in the network core (e.g., in switch S4). It can be seen that the number of in-fabric rate limiters depends at least to some extent on tenant placement, and localized tenant placement can significantly reduce the number of rate limiters.

As an example of global reasoning, tenant T2 has an providing two ports out of S1, three ports out of S5 and one port out of S6. The SLA provides bandwidth capacity alpha for each of these five ports. The leftmost port for switch S4 has a rule r2. This port separates two tenant T2 ports on the left from four tenant T2 ports on the right. Thus, a 2 times alpha size local rule r2 on the port from S4 to S3 is sufficient to support the tenant T2 SLA. This allows no more than 2 alpha units of tenant T2 bandwidth to move from S4 to S3.

It can be seen in the illustration shown in FIG. 7 that the minimum number of rate limiters is used, and each of the rate limiters that are used is provided (at least to the extent possible) only in the edge nodes. Such an approach minimizes the resources needed in the switches themselves.

Before continuing, it should be noted that the examples described above are provided for purposes of illustration, and are not intended to be limiting. Other devices and/or device configurations may be utilized to carry out the operations described herein.

Various packet encapsulation architectures such as PBS, NVGRE, and VXLAN may by be used with QLANs. By way of illustration, Provider Backbone Bridging (PBB) may be implemented for hosting customers in a shared datacenter, and provides a good platform to host the QLAN architecture described herein. PBB, sometimes called MAC-in-MAC, defines a standard approach (IEEE 802.1ah-2008) for hosting independent customers on a shared network. A customer's packet is encapsulated within a backbone packet that includes B-DA, B-SA, B-VID, and I-SID values. The B-DA, B-SA, and B-VID values identify backbone source and destination MAC addresses and the backbone VLAN ID. This allows Ethernet transport across a core and between Backbone Edge Bridges (BEBs) that are located at the edge of the backbone.

Because PBS encapsulates packets at the network edge, in ten switches forward packets using BEB addresses only, and are insulated from the large state needed to forward individual customer MAC addresses. The I-SID is a 24 bit service identifier that separates tenant address spaces. This allows distinct tenants to use identical MAC addresses and VLAN IDs without interference. BEB devices support learning which automatically builds a table that associates the MAC address, VLAN ID, and I-SID for each remote customer device with the address of the remote BEB associated with the customer's device. After a remote device entry is learned, a source BEB can quickly perform encapsulation to move the packet through the fabric to the correct remote BEB where the packet is unwrapped and delivered to the tenant. This process is transparent to tenant hardware and software.

The PBBI-SID provides an easily recognized tenant-specific value which may be implemented to identify an associated QLAN. Thus, the QoS to field Q can be directly taken as the I-SID, or extracted as a sub-field of the I-SID, or identified through a table lookup from the I-SID.

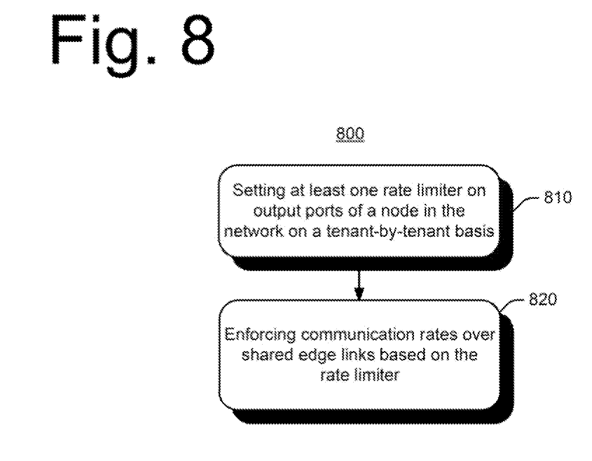

FIGS. 8-10 are flowcharts illustrating example operations 800, 900, and 1000, respectively, which may be implemented for network provisioning. In an example, the components and connections depicted in the figures may be used.

In FIG. 8, operation 810 includes setting at least one rate limiter on output ports of a node in the network on a tenant-by-tenant basis. Operation 820 includes enforcing communication rates over shared edge links based on the rate limiter. As such, the at least one rate limited protects shared resources. But excess in-tenant bandwidth may still be permitted on unshared resources.

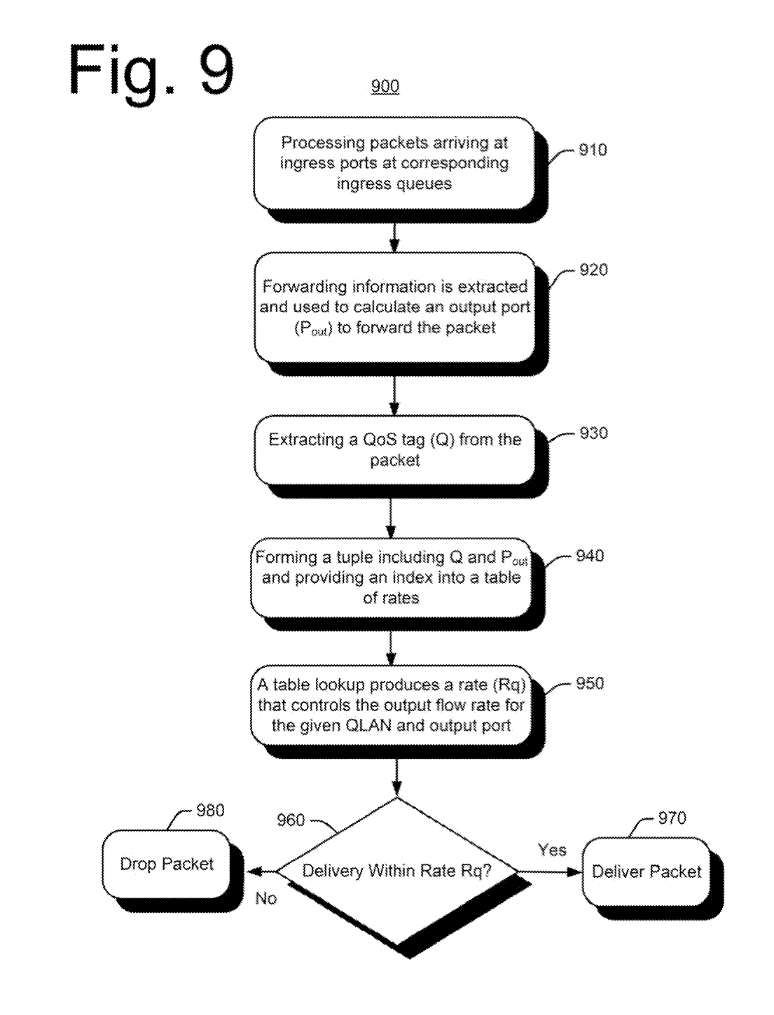

In FIG. 9, operation 910 includes processing packets arriving at ingress ports at corresponding ingress queues. In operation 920, forwarding information is extracted and used to calculate an output port (Pₒᵤₜ) to forward the packet. In operation 930, a QoS tag (Q) is extracted from the packet. In operation 940, a tuple including Q and Pₒᵤₜ is formed and provides an index into a table of rates 440. In operation 950, a table lookup produces a rate (Rq) that controls the output flow rate for the given QLAN and output port. A decision is made in operation 960. If the delivery is within the rate Rq, then in operation 970 the packet is delivered to the appropriate egress virtual port. If the delivery exceeds the rate, then in operation 980 the packet is dropped.

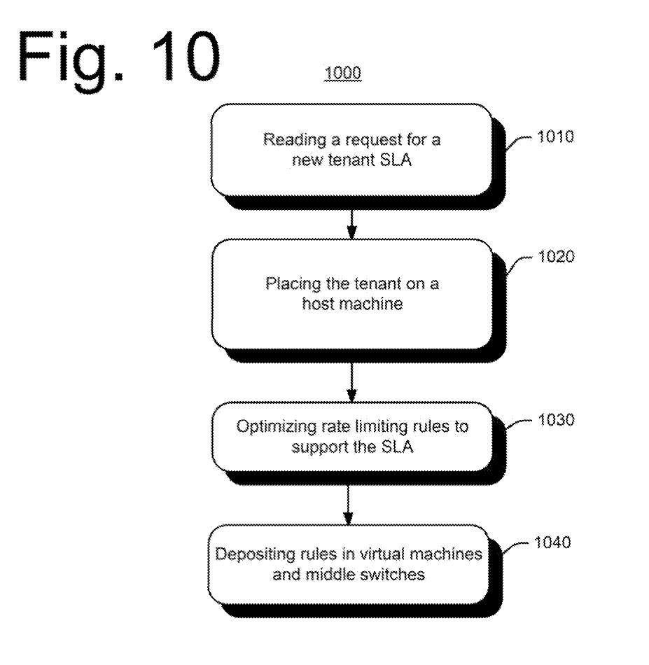

In FIG. 10, operation 1010 includes reading a request for a new tenant SLA. In operation 1020, placing the tenant on host machines. In operation 1030, optimizing rate limiting rules needed to support the SLA. In operation 1040, depositing rules appropriate virtual machines and middle switches.

The operations shown and described herein are provided to illustrate example implementations. It is noted that the operations are not limited to the ordering shown. Still other operations may also be implemented.

Further operations may include reducing rules based on global reasoning, for example, by pushing the at least one rate limiter to edge nodes in the network. A number of rate limiters depends on tenant placement in the network. The number of rate limiters can be reduced with localized tenant placement in the network. The rate limiters can positioned at merge points between tenants in the network.

Further operations may also include enforcing traffic rules at shared edge nodes in the network to prevent overloading the network and disrupting tenants in the network.

The operations described herein may be used for managing traffic in a network fabric. The operations described herein are used for minimizing the detrimental effect of over provisioning and/or disruption of network communications by one or more tenants.

It is noted that the examples shown and described are provided for purposes of illustration and are not intended to be limiting. Still other examples are also contemplated.

1. A method of multi-tenant network provisioning, comprising:
setting at least one rate limiter on output ports of a node in the network on a tenant-by-tenant basis; and
forcing communication rates over shared edge links based on the limiter.

2. The method of claim 1, further comprising reducing rules based on global reasoning.

3. The method of claim 1, further comprising pushing the at least one rate limiter to edge nodes in network.

4. The method of claim 1, wherein a number of rate limiters is selected based on tenant placement in the network.

5. The method of claim 1, further comprising reducing a number of rate limiters with localized tenant placement in the network.

6. The method of claim 1, further comprising enforcing traffic rules at shared edge nodes in the network to prevent overloading the network and disrupting tenants in the network.

7. The method of claim 1, further comprising positioning the at least one rate limiter at merge points between tenants in the network.

8. The method of claim 1, wherein the at least one rate limited protects shared resources.

9. The method of claim 1, further comprising permitting excess in-tenant bandwidth on unshared resources.

10. A multi-tenant network provisioning system, comprising:
a switch to enforce communication rates over shared edge links in a network; and
a module in the switch to process a Quality of Service (QoS) tag in a packet and determine if delivery of the packet satisfies at least one rate limiter on an output port of the switch.

11. The system of claim 10, wherein the at least one rate limiter is set in a network including the switch on a tenant-by-tenant basis.

12. The system of claim 10, wherein the QoS tag indicates a QLAN service ID tenant ID, and is carried in and extracted from the packet.

13. The system of claim 10, wherein a tuple including a queue (Q) and output port (Pout) provides an index into a table of rates.

14. The system of claim 13, wherein a table lookup produces a rate (Rq) that controls an output flow rate for the output port (Pout).

15. The system of claim 14, wherein if the module determines delivery is within the rate (Rq), the packet is delivered to an appropriate egress virtual port.

16. The system of claim 14, wherein if the module determines delivery exceeds the rate (Rq), then the packet is dropped.

17. The system of claim 10, wherein the switch enforces traffic rules at shared edge nodes in the network to prevent overloading the network and disrupting tenants in the network.

18. The system of claim 10, wherein the at least one rate limiter is pushed out to edge nodes in the network.

19. The system of claim 10, wherein the at least one rate limiter protects shared resources.

20. The system of claim 10, wherein the at least one rate limiter allows excess in-tenant bandwidth on unshared resources.
